(19) United States
(12) Patent Application Publication
(10) Pub. No.: US 2014/0078118 A1
(43) Pub. Date: Mar. 20, 2014

(54) HYGIENIC FINGER PROTECTOR

(71) Applicant: Stephen M. Robb, Henderson, NV (US)

(72) Inventor: Stephen M. Robb, Henderson, NV (US)

(21) Appl. No.: 14/085,592

(22) Filed: Nov. 20, 2013

Related U.S. Application Data
(63) Continuation-in-part of application No. 13/698,974, filed on Nov. 19, 2012.
Application No. 13/698,974 is a continuation of application No. 13/105,532, filed on May 11, 2011, now abandoned.
(60) Provisional application No. 61/346,302, filed on May 19, 2010.
(60) Provisional application No. 61/728,705, filed on Nov. 20, 2012.

(51) Int. Cl. G06F 3/0354

(52) U.S. Cl. CPC G06F 3/03545
USPC 345/179

(57) ABSTRACT

A hygienic finger protector includes a tubular sheath and an elastic stylus extending therefrom. The sheath is sized to be placed on a finger, extending to approximately the first joint. The elastic stylus is received within an aperture formed in the sheath, adjacent to the closed distal end. A securement flange extends inside the sheath and an enlarged stylus head projects outwardly from the sheath. The elastic stylus is electrically conductive enabling use of the stylus on touch-capacitive screens. A set of shims that are selectively attachable inside the sheath enables fine-tuning the interior sheath dimension. An appropriately-sized shim is placed inside and attached to the sheath to conform the interior size to that required for a snug fit.

### RELATED APPLICATIONS

This application claims the benefit of priority under 35 USC §119(e) to U.S. Provisional Application No. 61/728,705, filed on Nov. 20, 2012, and is a continuation-in-part of co-pending U.S. patent application Ser. No. 13/698,974, which was filed on Nov. 19, 2012, which was a §371 national phase filing of PCT/US2011/037114, which was filed on May 19, 2011, which was a continuation of U.S. patent application Ser. No. 13/105,532, which was filed on May 11, 2011, which claimed the benefit of U.S. Provisional Application Ser. No. 61/346,302, filed May 19, 2010; all identified applications are incorporated by reference herein for all that they contain.

### BACKGROUND OF THE INVENTION

1. Field of the Invention

The present invention relates generally to hygienic products, and more particularly, to an inexpensive finger protection device usable on public keypads and the like.

2. Background Information

Store customers are routinely required to interact with public data input devices. These public data input devices include keypads, card readers, and signature capture devices used by customers at checkout counters as they pay for merchandise and services. Public data input devices also include airline check-in kiosks, bank and ATM keypads, and the like where transactions are initiated, executed, and/or completed.

The practicality and usability of the public data input devices has led to great popularity, with large numbers of customers being required to touch the same relatively small contact surfaces throughout the day. The cleanliness of these contact surfaces thus suffers. Customers inadvertently transfer dirt and illness-causing microorganisms to the public data input devices simply by using them for their intended purpose.

The fingers of the customers may be particularly unsanitary at the end of a shopping trip due to the multitude of diverse surfaces touched as items for purchase are selected. Customers shopping in the garden section may come into contact with chemicals, fertilizers, and plants that can cause allergic reactions to others. When handling products of meat, poultry, fish, fruits and vegetables there are multiple ways of coming into contact with harmful bacteria, such as salmonella, campylobacter, and e-coli. Other customers may have a cold or other virus or may be supervising children who do. The use of public restrooms has always been an avenue of spreading germs and bacteria.

Currently there is no practical means or method to protect one customer from the containments and microorganisms left on the public data input devices by the previous customers.

Particularly when customers have a nick or cut on their hands, they are vulnerable to infection from common bacteria and viruses, as well as more alarming HIV, Hepatitis, herpes, blood-borne pathogens, or other infectious diseases. Placing gloves on the hand could protect the hand, but gloves are bulky, awkward, and inconvenient. Thus a need exists for a convenient protective device.

Further, the public data input devices may be impaired or damaged by the dirt from the customers' hands, thus necessitating repair. For example, dirt under a key of a keypad may cause that number or letter to become non-functional. Thus a device to protect the signature capture devices, keypads, and other digital input devices is advantageous.

Additionally, many companies give inexpensive promotional items to clients or tradeshow attendees to advertise their services or products. These items may be marked with logos, slogans, the company name, or other brand-image promoting graphics. Though numerous items are available, current inexpensive promotional items have been used repetitively, thus diminishing their impact and desirability. A new inexpensive, functional item that can be marked with promotional graphics is beneficial.

Accordingly, there is an established need for a practical, convenient hygienic finger protector capable of effectively protecting customers' fingers from microorganisms and dirt and capable of protecting public data input devices from dirt from fingers, yet inexpensive enough to be provided complementarily by companies as an advertising or promotional item.

### SUMMARY OF THE INVENTION

The present invention is directed to an inexpensive, practical hygienic finger protector for protecting against contamination by dirt or microorganisms, while allowing the wearer to input data or a signature into public data input devices such as keypads, ATM PIN pads, and signature capture devices.

The hygienic finger protector preferably includes a flexible, rubber-like, tubular sheath having a proximal open end and a distal closed end. The open end is adapted to receive a human finger. The finger protector is designed to reach to approximately the first finger joint.

The finger protector further includes a knob like protuberance (also might be described as a stud or bump) imbedded into the closed end of the sheath, disposed below the downward-facing fingertip of the inserted finger. The protuberance allows a user to input his or her signature into a digital signature capture device, such as used when signing for payment by a credit card of purchases at a retail store

An aspect of embodiments in accordance with the present invention is a hygienic finger protector comprising: a tubular sheath sized to accommodate a fingertip of a user and configured to fit over the fingertip to approximately a first joint of a finger, said tubular sheath having a closed distal end, said tubular sheath having a stylus aperture formed in said tubular sheath adjacent said closed distal end, and a proximal open end defining a finger-receiving opening; and an elastic stylus received within said stylus aperture, with a portion of said elastic stylus projecting beyond an outer surface of said tubular sheath and a separate portion projecting beyond an inner surface of said tubular sheath, wherein said elastic stylus is electrically conductive.

Another aspect of embodiments in accordance with the present invention is a fingertip stylus comprising: a tubular sheath adapted to be mounted on a finger of a user; and an elastic stylus attached to said tubular sheath, said elastic stylus having an enlarged stylus head projecting from an outer surface of said tubular sheath and having a portion extending through said tubular sheath and projecting from an inner surface of said tubular sheath, wherein said elastic stylus is electrically conductive.

Optional aspects, including a keychain attachment embedded data storage, and aesthetic cut-outs are presented.

An object of the present invention is to provide a hygienic finger protector that protects a finger from unsanitary conditions.

A further object of the present invention is to provide a hygienic finger protector that is practical to use for inputting a digital signature in a signature capture device.

Another object of the present invention is to provide a hygienic finger protector that provides a suitable carrier for a logo or other graphic.

An additional aspect of the present invention is to provide a hygienic finger protector that can be customized.

These and other objects, features and advantages of the present invention will become more readily apparent from the attached drawings and from the detailed description of the preferred embodiments, which follow

### BRIEF DESCRIPTION OF THE DRAWINGS

Embodiments in accordance with the present invention are described below in connection with the accompanying drawing sheets.

FIG. 1 is a perspective view showing a first embodiment of the hygienic finger protector of the present invention as utilized on an index finger of a wearer.

FIG. 2 is a perspective view showing a first embodiment of the hygienic finger protector of the present invention.

FIG. 3 is a cut view taken along the lines 3-3 of FIG. 2, showing a first embodiment of the hygienic finger protector of the present invention.

FIG. 4 is a side view showing a second embodiment of the hygienic finger protector of the present invention.

FIG. 5 is a front: view showing a second embodiment of the hygienic finger protector of the present invention.

FIG. 6 is a cut view taken along the lines 6-6 of FIG. 5, showing a second embodiment of the hygienic finger protector of the present invention.

FIG. 7 is a front view showing a third embodiment of the hygienic finger protector of the present invention.

FIG. 8 is a side view showing a fourth embodiment of the hygienic finger protector of the present invention.

FIG. 9 is a side view showing a fifth embodiment of the hygienic finger protector of the present invention.

FIG. 10 is a side perspective view showing a sixth preferred embodiment of the hygienic finger protector of the present invention.

FIG. 11 is a side perspective view chewing the sixth preferred embodiment of the hygienic finger protector of the present invention.

FIG. 12 is an end perspective view showing the sixth preferred embodiment of the hygienic finger protector of the present invention.

FIG. 13 is a rear side perspective view showing the sixth preferred embodiment of the hygienic finger protector of the present invention.

FIG. 14 is a side perspective view showing the seventh embodiment of the hygienic finger protector of the present invention.

FIG. 15 is a bottom perspective view of an alternate embodiment of the present invention utilizing an elastic stylus.

FIG. 16 is a side elevation view of the alternative embodiment of FIG. 15.

FIG. 17 is a cross-sectional view of the alternative embodiment of FIG. 15.

FIG. 18 is a partial exploded cross-sectional view of the manner of attachment of the elastic stylus of the alternative embodiment of FIG. 15.

FIG. 19 is a partial cross-sectional view, similar to FIG. 18, showing the elastic stylus as mounted in the sheath wall.

FIG. 20 is a side elevation view showing a shim attached to an interior surface of the interior of the alternative embodiment of FIG. 15.

FIG. 21 is a side elevation view in cross-section showing attachment of the shim to an upper interior surface of the alternative embodiment of FIG. 15.

FIG. 21A is a partial sectional view taken within the circle shown in FIG. 21 showing a manner of attachment of the shim to an upper interior surface of the interior of the alternative embodiment of FIG. 15.

FIG. 22 is an exploded top plan view, with portions in phantom, showing placement of a shim within an alternative embodiment of the hygienic finger protector in accordance with the present invention.

FIG. 23 is an exploded top plan view, with portions in phantom, similar to FIG. 22, of a shim placed within an embodiment of the hygienic finger protector having a fingernail opening in accordance with the present invention.

FIG. 24 is a cross-sectional view taking along line 24-24 of FIG. 23 showing a protector having a fingernail cutout in accordance with the present invention.

### DETAILED DESCRIPTION OF THE PREFERRED EMBODIMENTS

The hygienic finger protector is disclosed herein with respect to exemplary embodiments. The embodiments are disclosed for illustration of the hygienic finger protector and one or more manners of operation, and are not limiting except as defined in the appended claims.

Shown throughout the figures, the present invention is directed toward a hygienic finger protector that is easily and quickly donned when needed for shielding the finger from dirt, contamination, and microorganisms, yet allows the wearer to directly sign a signature capture device to input a digital signature, as well as to input data into keypads, number pads, PIN pads, and the like. Further, the hygienic finger protector is inexpensive and easily imprintable, allowing usage as a carrier for logos, slogans, the company name, or other brand-image promoting graphics. Additionally, the hygienic finger protector of the present invention permits incorporation of one or more cutouts of any of a variety of shapes, permitting further customization.

Reference is now made to the drawings wherein like structures refer to like parts throughout.

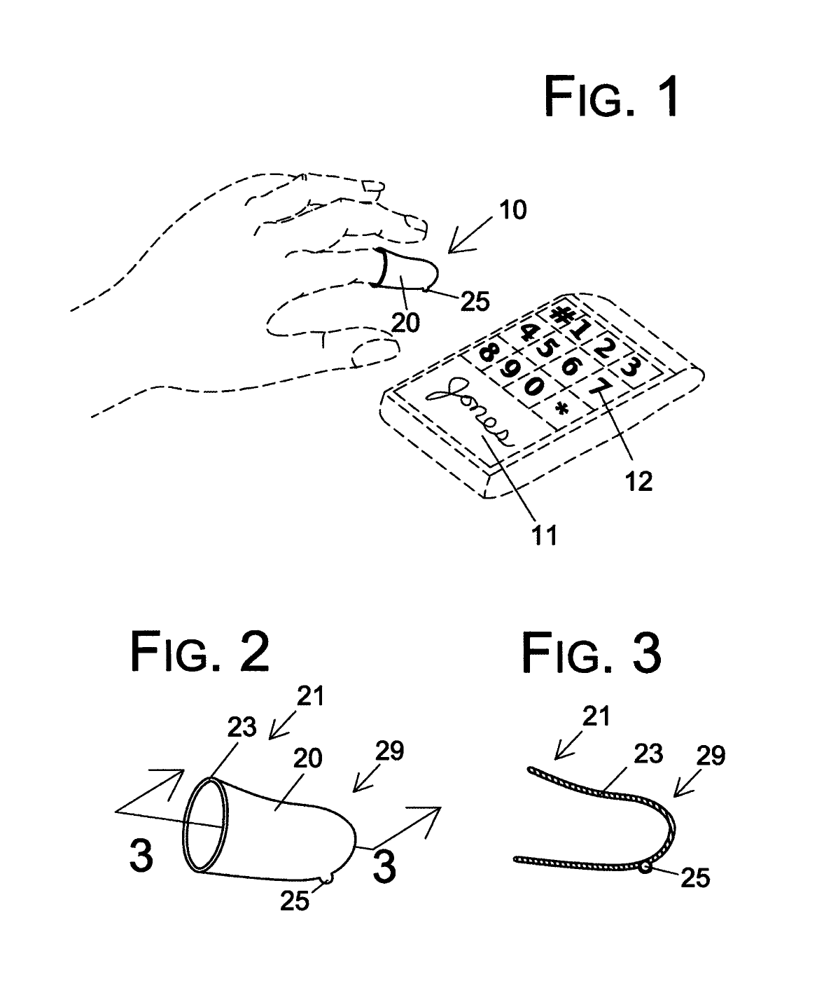

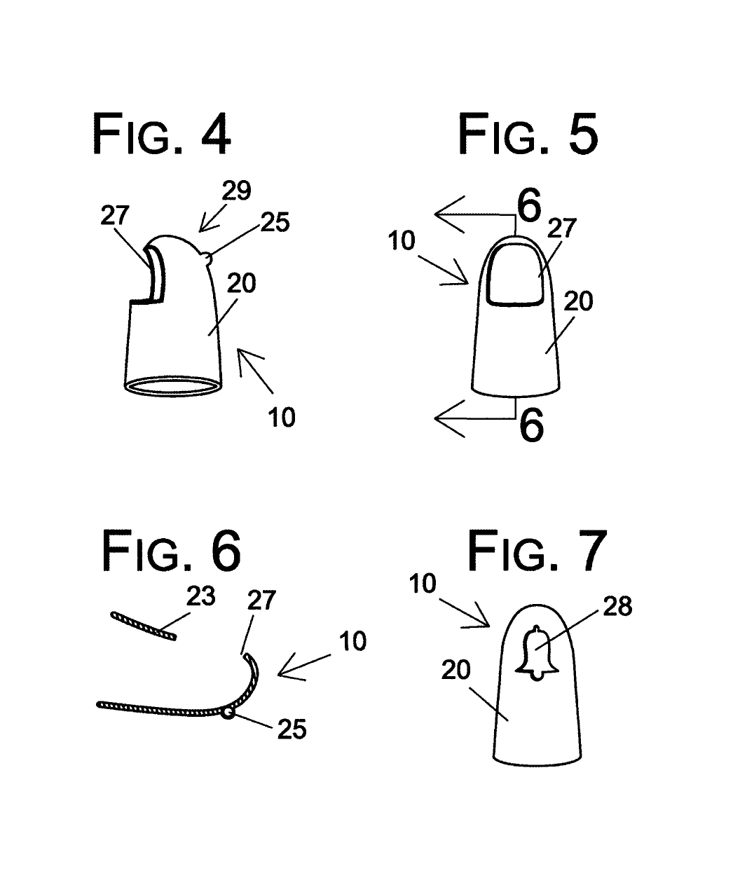

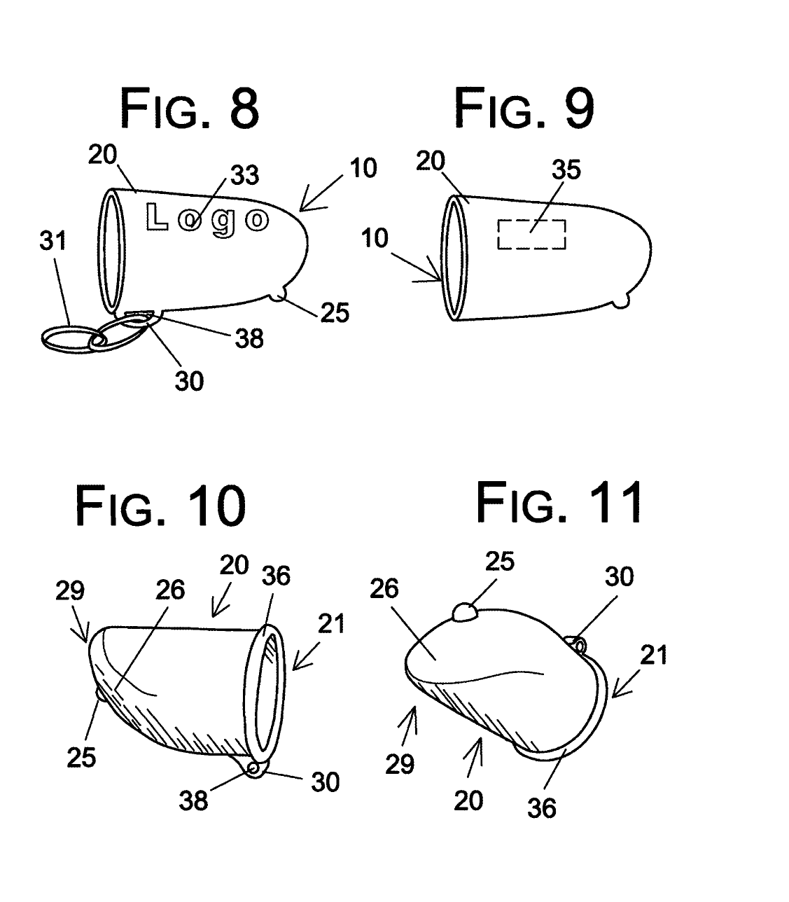

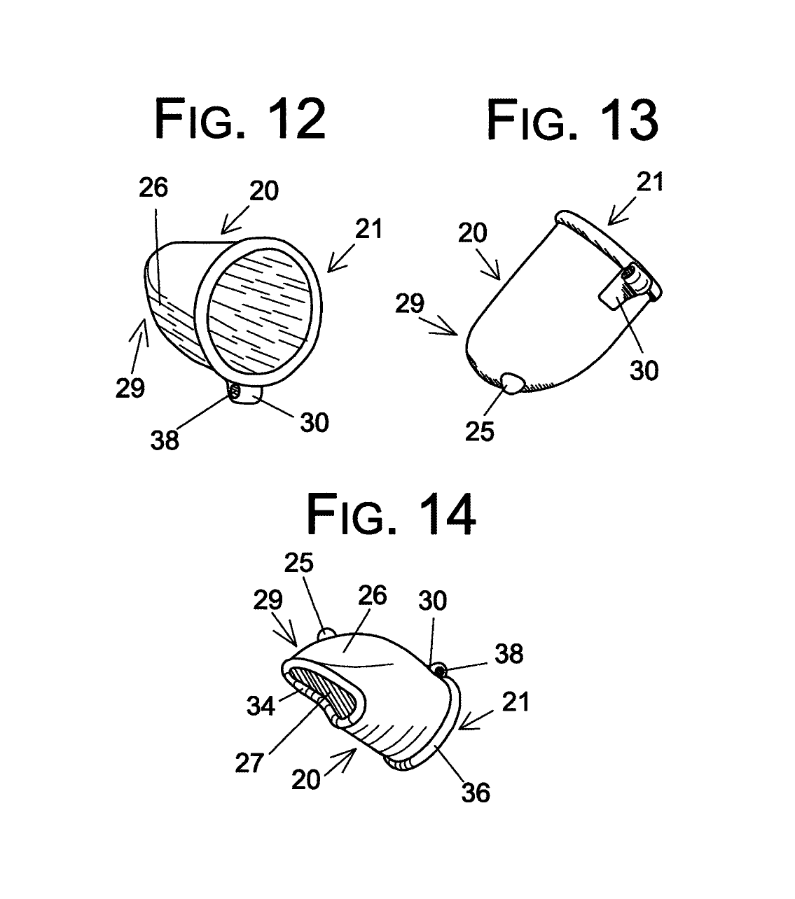

Seven embodiments are presented, a first embodiment, (FIG. 1 to FIG. 3), a second embodiment illustrating a fingernail-shaped cutout 27 (FIG. 4 to FIG. 6), a third embodiment illustrating a customized cutout 28 (FIG. 7), a fourth embodiment illustrating an indicium (such as an imprinted logo or brand-image promoting graphic 33) and a keychain attachment 30 (FIG. 8), a fifth embodiment illustrating an embedded data storage device 35 (FIG. 9), a contoured sixth preferred embodiment, (FIG. 10 to FIG. 13), a contoured seventh embodiment with a fingernail-shaped cutout 27 (FIG. 14).

Referring now to FIG. 1, a hygienic finger protector, shown generally as reference number 10, is illustrated in accordance with a first embodiment of the present invention, as being utilized on a wearer's index finger for directly signing a signature capture device 11 or for inputting data into the number Pad 12. As shown, the hygienic finger protector 10 comprises a tubular sheath 20 and a knob-like protuberance 25 embedded within the tubular sheath 20.

The tubular sheath 20 has a proximal open end 21, has a distal closed end 29, and has a sheath wall 23 of an adequate thickness to retain embedded knob-like protuberance 25. The distal closed end 29 is cone-shaped with a somewhat elongated tube extending to open end 21. The tubular sheath 20 is sized and configured to receive a human finger (generally an index finger). When inserted, the fingertip generally abuts the closed end 29. The proximal open end 21 is configured with a finger-receiving opening sized to allow a fingertip to be inserted.

The hygienic finger protector may be offered in multiple sizes to accommodate fingers of differing sizes (such as, small, medium, and large), with the tubular sheath 20 varying both in length and in diameter of the open end 21. Preferably the tubular sheath 20 is configured to reach to approximately the first joint of the finger, though variations in length are within the scope of the invention.

The sheath wall 23 is preferably formed of a natural or man-made rubber-like material. The rubber-like material is thicker than commonly available latex finger cots, thereby increasing strength and durability. Also, the rubber-like material is sufficiently thick (FIG. 2, FIG. 3) to retain the embedded knob-like protuberance 25 within the sheath wall 23. Optionally, the sheath wall 23 may he formed of a rigid plastic, flexible plastic, or a combination of rigid plastic and flexible plastic. For example, the distal end may be formed of a rigid plastic with the protuberance 25 formed unitarily with the distal end, with a flexible plastic proximal portion non-removably joined to the rigid plastic distal portion. Or, alternatively, the entire sheath wall 23 could be formed integrally with the protuberance 25 of a rigid plastic. Preferably the sheath, open end 21, and closed end 29 are formed of flexible, rubber-like material with the protuberance 25 formed of a more rigid plastic.

The knob-like protuberance 25 is preferably a spheroidal or ovoidal bead of plastic, with the plastic having a sufficient rigidity to impress a signature into a signature capture device. The protuberance 25 is adapted to be pressed against the signature capture device to create a focus of pressure satisfactory to input the signature. Optionally, the protuberance 25 may be formed of metal, may be magnetized, or have the operative properties of an electromagnetic pen meeting the standard specifications for electromagnetic pens used with electronic signature pad sensors to create a digital signature.

The protuberance 25 is located in a downward-facing position toward the closed end 29, situated under the fingertip of the wearer for convenience of inputting a signature. Protuberance 25 may be approximately ⅛ to ⅜ inches in diameter, as illustrated. During manufacture the knob-like protuberance 25 may be placed and positioned in the viscous rubber-like material before hardening.

Referring now to FIG. 4 to FIG. 6, the second embodiment of the hygienic finger protector 10 provides a fingernail-shaped cutout 27 configured to allow the nail of the wearer to be displayed through cutout 27 and configured to accommodate longer nails, artificial nail tips, fashion nails, nail enhancements, or nail extensions. The cutout 27 allows the display of nail polish and nail art designs.

The third embodiment of FIG. 7 illustrates a customized cutout 28. The customized cutout 28 provides a high degree of adaptability to current trends and marketing needs, allowing customization for particular companies (via logos or other brand-image promoting shapes) and/or for timely retail sales (seasonal shapes).

Cutout 27 and cutout 28 may be cut or trimmed after fabrication of sheath 20 or sheath 20 may be molded with cutout. 27, 28 formed unitarily.

The fourth embodiment illustrates the utilization of printing to customize the hygienic finger protector 10. The sheath 20 is imprinted with indicium or indicia 33, such as a desirable, marketable graphic. The marketable graphic 33 is designed to increase the desirability and personalization of the hygienic finger protector 10. For example, the indicium 33 may be artwork; a slogan, saying, or other text; or a company-related image, logo, or other brand-image promoting graphic.

Optionally, cutout 27 or customized cutout 28 may be utilized with the imprinting of the brand-image promoting graphic, indicium 33.

The fourth embodiment of FIG. 8 further includes an extended bulge 30 or thickened region of sheath 23 having an aperture 38 configured to receive a key ring or keychain 31. The aperture 38 may he simply an opening in the extended bulge 30 or, for more durability, may have a grommet embedded into extended bulge 30 with a center aperture to receive a key ring or keychain 31.

The fifth embodiment of FIG. 9 illustrates an embedded data storage device 35. The embedded data storage device 35 is operable to store data and, in some aspects, to transmit data. The data storage device 35 may be a barcode, RFID tag (radio frequency identification label generally configured with an integrated circuit to store and process data and to modulate and demodulate a radio-frequency signal and configured with an antenna), a keycard (configured to store a digital signature), a smart card (operable to process data by way of an integrated circuit and to receive input and deliver output), or the like.

The embedded data storage device 35 allows enhanced customization. The embedded data storage device 35 can be configured to supply identification information. For example, the stored data may be a preferred shopper number to allow the customer wearing the hygienic finger protector to obtain discounts or the stored data may designate a group affiliation, such as allowing the customer to he identified with a particular school for enabling school rewards.

FIG. 10 to FIG. 13 illustrate the sixth embodiment of the hygienic finger protector 10, which includes a contour 26 of sheath 20 and a raised rim 36. An alternate keychain attachment 30 is also shown. The keychain attachment 30 has an interior aperture 38 sized and configured for receiving a keychain, a ring, a cord, a cable, or the like.

The contour 26 is a curved shape that allows the distal end 29 of sheath 20 to generally conform to the shape of a typical fingertip. The incorporation of the contour 26 reduces or prevents rotation of the finger protector 10 with relation to the inserted fingertip. The contour 26 may include both an interior contour and/or an exterior contour.

The raised rim 36 is a circumferential rounded rim at the edge of proximal open end 21. The raised rim 36 provides a smooth entrance for the fingertip, allowing quick and easy insertion. Allowing the finger protector 10 to be quickly donned provides an advantage in rushed situations, such as when ready to sign a digital signature pad or input a PIN number at a busy store checkout counter. Additionally, the raised rim 36 provides an aesthetically pleasing, finished appearance for the edge. Optionally, the raised rim 36 or other portion of the sheath may be formed in a second color to enhance the appeal of the finger protector 10.

FIG. 14 illustrates the seventh embodiment of the present invention, which incorporates the features of the sixth embodiment and, adds a cutout rim 34. The cutout rim 34 is a rounded rim at the edge of cutout 27. Similar to the circumferential raised rim 36, the cutout rim 34 provides a smooth, pleasing finished appearance for the edge. Preferably both the circumferential raised rim 36 and the cutout rim 34 are unitarily molded with sheath 20.

To use the hygienic finger protector 10, the customer inserts his finger (generally the index finger) into the sheath 20 until the tip of the finger abuts the distal closed end 29 of sheath 20. The finger, covered by the hygienic finger protector 10, may be used to input numbers into the keypad 12 (such as PIN numbers, phone numbers, etc.). Optionally, the protuberance 25 may be pressed against the signature capture device 12 and moved to create a signature. The finger is thus protected from dirt and bacteria and viruses such as, for example, HIV, Hepatitis, herpes, blood-borne pathogens, and other infections) that contaminate the keypad 12 or signature capture device 11. Also, the keypad 12 and signature capture device 11 are protected from dirt from customers' hands, which may lead to less maintenance and cleaning, saving employee time and reducing costs.

Companies may choose to customize the hygienic finger protector 10 and to provide the customized finger protectors 10 to clients and customers to create goodwill, brand recognition, and the like. Due to the low cost per hygienic finger protector 10, they may advantageously be used as complimentary promotional items to give to tradeshow attendees to advertise services or products.

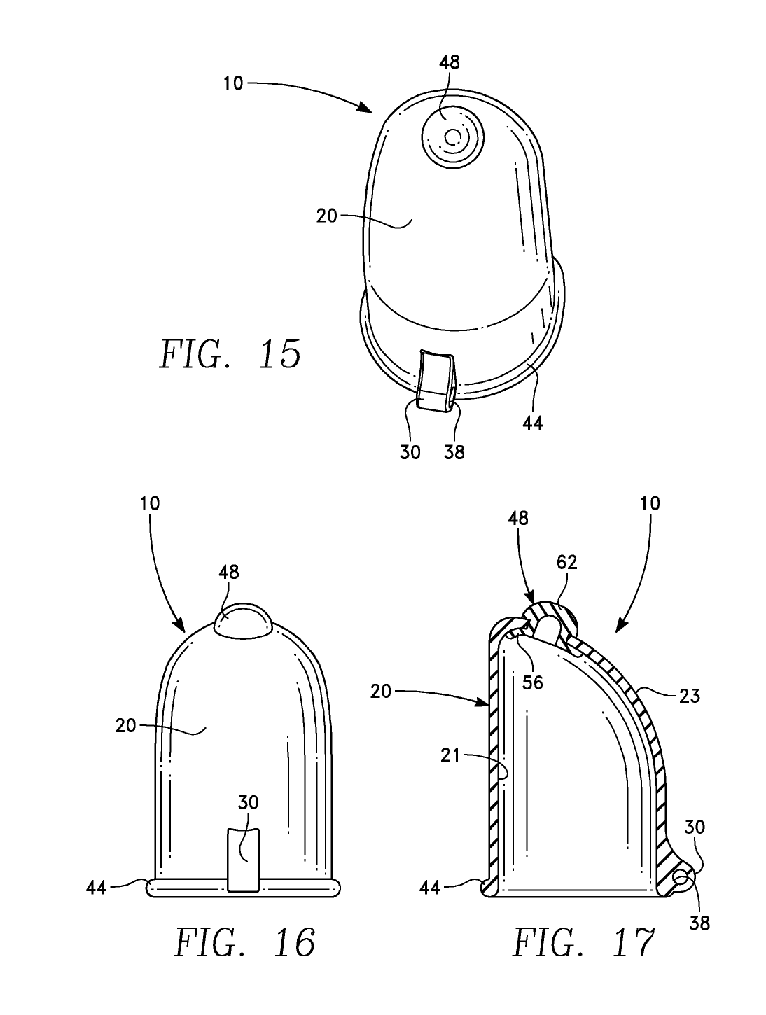

Presently preferred alternative embodiments are depicted in FIGS. 15-23. FIGS. 15-17 depict a rolled collar 44 (also known as a “bond beam”) that is formed adjacent to the open end 21 of the tubular sheath 20. The rolled collar 44 provides both additional strength to the edge of the tubular sheath 20 and the rounded edge minimizes the risk of abrasion to the user as the finger is inserted into the tubular sheath 20 - as compared to a narrower edge shown in some of the previous embodiments.

As is also shown in FIGS. 15-17 the hygienic finger protector 10 utilizes an elastic stylus 48 that is preferably electrically conductive enabling use of the elastic stylus 48 to communicate with touch-capacitive surfaces, such as, for example devices with touchscreens, including all-in-one computers, tablet computers, and smartphones. The elastic stylus 48 may be fabricated out of rubber, silicon or the like, and incorporates such conductive material as carbon dust to enable electrical conductivity through the elastic stylus 48.

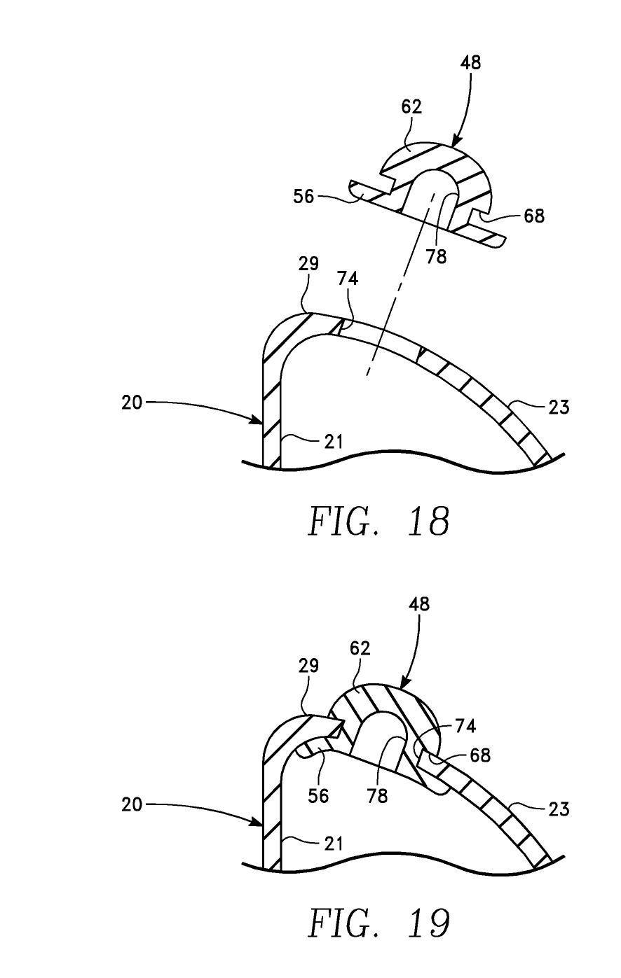

Additional details are shown in FIG. 17, with the elastic stylus captured by the sheath wall 23, a securement flange 56 in contact with an adjacent interior surface of the tubular sheath 20 and an outer enlarged stylus head 62 in contact with an adjacent exterior surface of the tubular sheath 20. This manner of attachment is best shown and described with reference to FIGS. 18 and 19.

As shown in FIG. 18 a neck 68 is formed in the elastic stylus 48 between the enlarged stylus head 62 and the securement flange 56. The stylus neck 68 is sized to be received by a stylus aperture 74 is formed in the sheath wall 23 and located adjacent to the closed end 29 of the tubular sheath 20. In FIG. 19 the elastic stylus 48 is shown received within the stylus aperture 74 and thereby secured to the tubular sheath 20 adjacent to the closed end 29. An interior cavity 78 formed within the cavity provides added spring and compliance to the elastic stylus 48, in addition to minimizing the amount of material required for this component part.

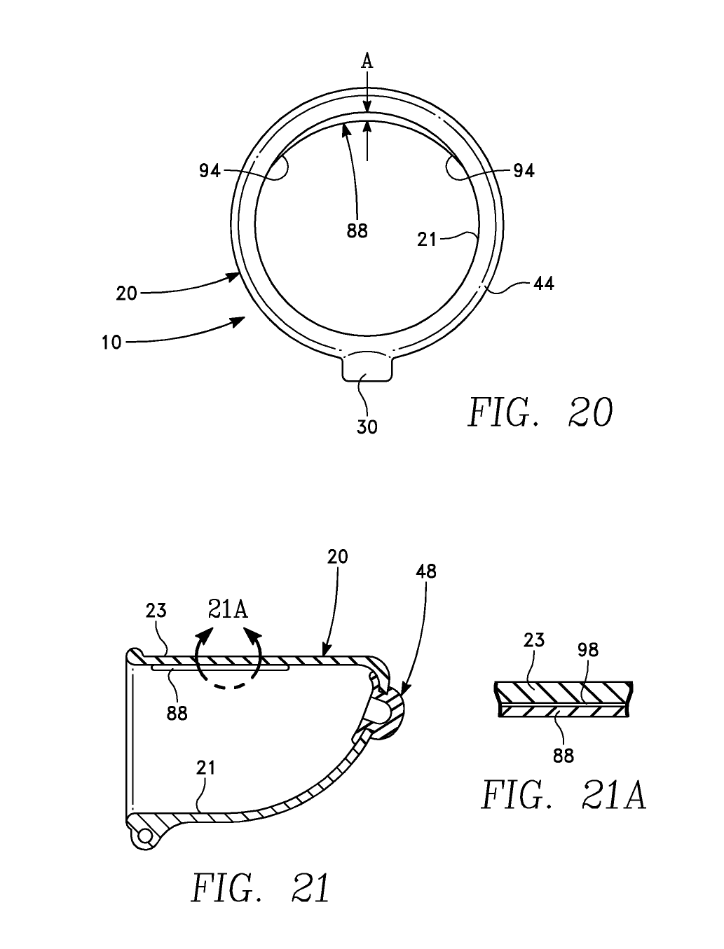

As mentioned previously it is presently contemplated to provide the hygienic finger protector 10 in multiple sizes: small, medium, large, and extra-large. FIG. 20 depicts the use of a shim 88 to “fine tune” the fitting of the finger protector 10. The shim 88 is attached to the upper inside surface of the tubular sheath 20, and is thicker at the center of the shim (denoted by Arrows A), terminating in a pair of tapered ends 94 to effect a smooth transition to the adjoining inner walls of the tubular sheath 20. In a presently preferred embodiment thickness of the shim 88 will vary, with a plurality of thicknesses provided, including 0.30, 0.040, and 0.050 centimeters. These different-sized shims enable the inside dimensions of the finger protector 10 to accommodate the finger dimensions of virtually any potential user.

FIG. 21 depicts the shim 88 as attached to an inside surface of the sheath wall 23. As shown in enlarged FIG. 21A an adhesive layer 98 is formed between the inside surface of the sheath wall 23 and an upper surface of the shim 88 to attach and hold the shim 88 in place within the tubular sheath 20. Appropriate adhesives for attaching the shim 88 include rubber cement, nail glue, and such general adhesives as are commonly found in retail stores.

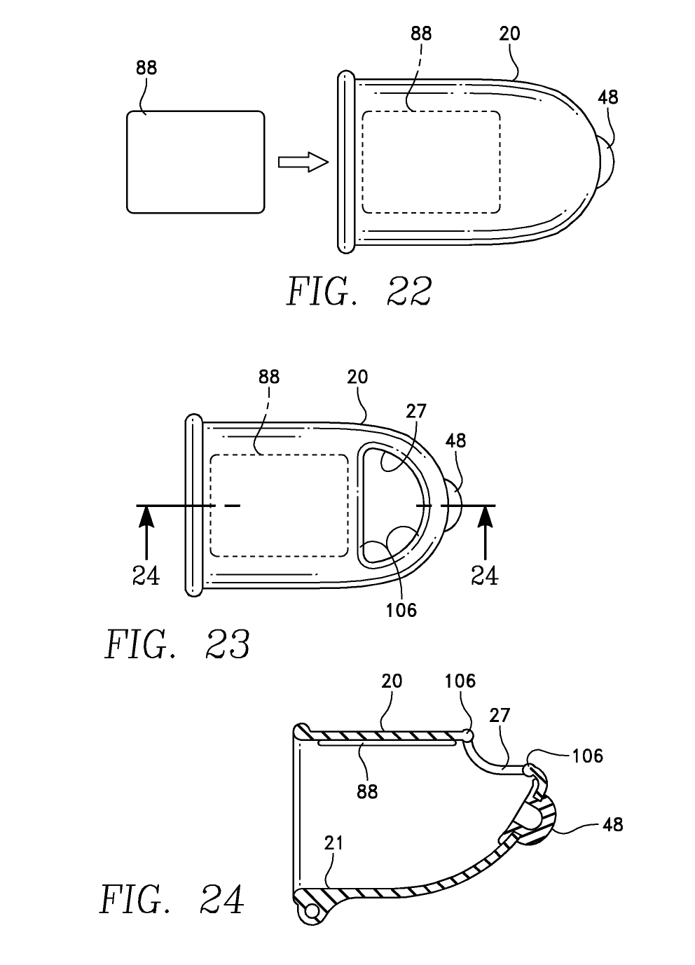

The shim 88 extends approximately one-half inch into the tubular sheath 20, as is depicted in FIG. 22. FIG. 23 depicts a tubular sheath 20 having the fingernail cutout 27, and the shim 88 does not extend to the initial cutout opening, so only one set of shims need be provided, regardless of whether or not the fingernail cutout 27 is provided. Note also in FIG. 23 that a cutout rolled collar 106 is provided around the perimeter of the fingernail cutout 27, providing similar benefits as were discussed in connection with the rolled collar 44, above. The cutout rolled collar 106 is also shown in FIG. 24.

Although the shims 88 can be fabricated out of various materials, plastic is presently preferred. As discussed, the shim 88 is attached by the user to the upper inside surface of the tubular sheath 20 and held in place using an adhesive. The smooth, lower inner surface of the finger protector is not disturbed, preserving user experience as compared to an un-shimmed finger protector. Attachment of the shim 88 provides a user with a uniform snug fit, enhancing user comfort during use of the finger protector 10.

Although not shown in the drawings, it is further contemplated to offer the hygienic finger protector with an upper, outer surface provided with a raised, roughened surface. Such a surface better retains printed images as compared to a smooth surface. This roughened surface is deemed useful for inviting the application of a wide variety of artwork, the raised nature enabling use of 3-D printing technologies. It is contemplated that fabrication of this enhanced surface will occur during injection molding of the finger protector.

The use of antimicrobial polymer additives to the plastic used to form the finger protector is also contemplated as a further enhancement to the present invention. Combined with the plastic feed stock prior to fabrication of the finger protector, the antimicrobial agent(s) provide an outer surface of the finger protector that resists the growth of pathogenic bacteria and fungi even after repeated washings.

Since many modifications, variations and changes in detail can be made to the described preferred embodiments of the invention, it is intended that all matters in the foregoing description and shown in the accompanying drawings be interpreted as illustrative, and not in a limiting sense. Thus, the scope of the invention should be determined by the appended claims and their legal equivalents.

What is claimed is:

1. A hygienic finger protector comprising:
a tubular sheath sized to accommodate a fingertip of a user and configured to fit over the fingertip to approximately a first joint of a finger, said tubular sheath having a closed distal end, said tubular sheath having a stylus aperture formed in said tubular sheath adjacent said closed distal end, and a proximal open end defining a finger-receiving opening; and
an elastic stylus received within said stylus aperture, with a portion of said elastic stylus projecting beyond an outer surface of said tubular sheath and a separate portion projecting beyond an inner surface of said tubular sheath, wherein said elastic stylus is electrically conductive.

2. The hygienic finger protector of claim 1, wherein said portion of said elastic stylus projecting beyond an outer surface of said tubular sheath comprises an enlarged stylus head.

3. The hygienic finger protector of claim 2, wherein a portion of said elastic stylus projects beyond an inner surface of said tubular sheath, said portion of said elastic stylus projecting beyond an inner surface or said tubular sheath comprises a securement flange.

4. The hygienic finger protector of claim 3, wherein a neck is formed in said elastic stylus, said neck interposed between said securement flange and said enlarged stylus head, said neck extends through and is received by said stylus aperture.

5. The hygienic finger protector of claim 1, and further comprising a shim selectively attached to an inner surface of said tubular sheath.

6. The hygienic finger protector of claim 5, wherein a plurality of shims are provided, each of a differing thickness, and said selectively attached shim conforms an interior diameter of said tubular sheath to match a corresponding fingertip dimension of said user.

7. The hygienic finger protector of claim 5, wherein said shim is crescent-shaped in lateral cross-section, having a thicker mid-portion and a pair of tapered ends.

8. The hygienic finger protector of claim 1, wherein a fingernail cutout is formed in said tubular sheath at a location spaced from said closed distal end, said fingernail cutout configured in a manner enabling at least a portion of a fingernail to extend therethrough upon insertion of said fingertip into said tubular sheath.

9. A fingertip stylus comprising:
a tubular sheath adapted to be mounted on a finger of a user; and
an elastic stylus attached to said tubular sheath, said elastic stylus having an enlarged stylus head projecting from an outer surface of said tubular sheath and having a portion extending through said tubular sheath and projecting from an inner surface of said tubular sheath, wherein said elastic stylus is electrically conductive.

10. The fingertip stylus of claim 9, wherein said tubular sheath has a proximal open end defining a finger-receiving opening and a closed distal end.

11. The fingertip stylus of claim 10, wherein a stylus aperture is formed in said tubular end adjacent said closed distal end and wherein said elastic stylus is received within said stylus aperture.

12. The fingertip stylus of claim 11, wherein the portion of said elastic stylus projecting from the inner surface of said tubular sheath is configured to contact a surface of the finger upon mounting said tubular sheath thereon.

13. The fingertip stylus of claim 10, and further comprising a shim selectively attached to an inner surface of said tubular sheath.

14. The fingertip stylus of claim 13, wherein said shim extends inwardly within said tubular sheath from a location adjacent said proximal open end.

15. The fingertip stylus of claim 14, wherein a terminus of said shim is in spaced-apart relation with said closed distal end.

16. The fingertip stylus of claim 15, wherein a fingernail cutout is formed in said tubular sheath at a location spaced from said closed distal end.
